(19) United States
(12) Patent Application Publication
(10) Pub. No.: US 2012/0272630 A1
(43) Pub. Date: Nov. 1, 2012

(54) CONTROLLED FLOW AIR PRECLEANER

(76) Inventor: Michael F. James, Carlisle (CA)

(21) Appl. No.: 12/682,843

(22) PCT Filed: Apr. 30, 2008
(86) PCT No.: PCT/US08/61987

§ 371 Date: Jun. 4, 2010

Related U.S. Application Data
(60) Provisional application No. 60/980,935, filed on Oct. 18, 2007.

(51) Int. Cl. B01D 45/08

(52) U.S. Cl. 55/456

(57) ABSTRACT

An air precleaner includes a housing defining an air chamber with a downwardly opening outlet and a pair of side inlets. A plurality of vanes in the air chamber define two pathways for intake air to flow from the inlet openings around bends of more than 90 degrees to the outlet opening. The pathways initially narrow to increase the velocity of air in the bends. An ejection compartment between the pathways includes two ejection openings at the ends of the bends for receiving contaminants transferred to an outer layer of the air by centrifugal force. The collected contaminants exit the housing through an evacuation opening. Downstream of the ejection openings, the pathways gradually widen to decrease the velocity of the precleaned air prior to reaching the outlet opening. The precleaner may be applied to an engine intake air cleaner or to the intake air of a cooling package.

### CROSS-REFERENCE TO RELATED APPLICATIONS

This application claims the benefit of U.S. Provisional Patent Application Ser. No. 60/980,935, filed on Oct. 18, 2007, which is hereby incorporated by reference in its entirety.

### STATEMENT OF FEDERALLY SPONSORED RESEARCH/DEVELOPMENT

Not applicable.

### BACKGROUND OF THE INVENTION

This invention relates to a precleaner such as used for the air intake system of a heavy duty vehicle.

Air often includes particulate matter such as dirt, dust, sand, snow and the like. While most engines include air filters designed to remove such contaminants from the air that feeds the engine, these filters may quickly become saturated and need replacement. To extend the life of air filters, extend the engine's life, and improve fuel economy, air precleaners have been added to many engines. Air precleaners commonly remove entrained contaminants or particulates from the intake air before the air enters an air filter of an internal combustion engine. Additionally, air precleaners may pre-filter make-up air for vehicle cabins.

Precleaners are typically mounted to the inlet side of the air intake manifold adjacent the air filter. Air enters the precleaner from the vacuum created by the engine. Typically, the air and entrained contaminants traverse a set of stationary vanes which cause the air to circulate at a great speed. Centrifugal force moves the contaminants toward an outer diameter wall of the precleaner along which the contaminants travel until they reach an opening where the contaminants are collected or ejected to the outside of the precleaner. The precleaned air then passes through the air filter and into the engine.

Several other designs of air precleaners are commercially available in the marketplace. In one design, an air precleaner uses a rotatable impeller or spinner to separate particles from air, discharge the dirty air and particle mixture circumferentially from a housing and direct the clean air to the engine air intake. This air precleaner has an air inlet vane assembly located in the bottom of the housing. The air flows upwardly in a circular path into a centrifugal separation chamber and then turns downwardly into the centrally-located clean air exit opening. The impeller is used to pump air and particulate matter out through side discharge openings. This type of air precleaner, however, does not take full advantage of the power of the vortex-like air flow in the mouth region of the clean air outlet passage.

In another type of known air precleaner, air flows into the top of the air precleaner, axially downward through the precleaner and into the intake stack of the engine. Although such precleaners may adequately separate out particulate material, they may also restrict air flow. The known precleaners of this type do not use static vanes that help cause efficient air circulation. Also, some of these precleaners are only useable when positioned in one orientation, i.e., positioned on a vertical axis or positioned on a horizontal axis, thereby restricting their application.

Thus, conventional precleaners require high flow velocities combined with abrupt changes in air flow direction and uncontrolled deceleration. These precleaners create an undesirably high static pressure drop between the inlet and outlet of the precleaner and are generally inefficient in the way they handle air flow. Rotating members common in many precleaners increase the undesirable pressure drop. The large pressure drop results in restricted air flow to the engine, and therefore loss of engine power.

Accordingly, there exists a need in the art for an improved air precleaner overcoming the foregoing difficulties and providing improved efficiency.

### SUMMARY OF THE INVENTION

The invention provides an air precleaner for removing entrained contaminants from intake air prior to entering an air filter in which the air flow is carefully shaped while in the precleaner to reduce pressure losses.

Specifically, the air precleaner includes a housing having side walls defining an air chamber. An inlet opening allows intake air into the air chamber which exhausts primarily through an outlet opening. The inlet opening has a greater cross-sectional area than the outlet opening. A plurality of vanes in the air chamber extend between opposite side walls of the housing to define a pathway for intake air to flow from the inlet opening around a bend of more than 90 degrees to the outlet opening. The pathway gradually narrows from the inlet opening to the outlet opening so as to increase the velocity of the intake from the inlet opening to the end of the bend where, at the outer perimeter of which, there is an ejection opening for receiving contaminants transferred to an outer layer of the intake air by centrifugal force caused by the intake air passing around the bend. The pathway gradually widens so as to decrease the velocity of the intake air from the ejection opening to the outlet opening.

In preferred forms of the precleaner, the housing includes a second inlet opening and a second plurality of vanes defining a second pathway extending from the second inlet opening to the outlet opening. The housing can also include an ejection compartment adjacent the ejection opening for collecting contaminants from the intake air passing through the ejection opening. An evacuation opening in the ejection compartment allows the collected contaminants to exit from the housing. A particle scavenger can be attached to the housing in fluid communication with the evacuation opening. Preferably, the ejection and evacuation openings are spaced apart from the inlet opening so that ejected debris are not redrawn into the intake opening.

Thus, the present invention provides an efficient air precleaner for reducing or eliminating airborne contaminants from engine intake air prior to entering the air filter. The precleaner is designed to control the air flow to significantly reduce static and dynamic pressure losses that would otherwise occur in less efficient precleaners, resulting from high flow velocities, abrupt change of direction, and uncontrolled deceleration. Reducing the pressure losses ultimately improves the efficiency and power output of the engine. Moreover, the precleaner allows for the collected debris to be evacuated at a location away from the inlet manifold to prevent recirculating it through the precleaner.

These and other advantages of the invention will be apparent from the detailed description and drawings.

### BRIEF DESCRIPTION OF THE DRAWINGS

FIG. 1 is a perspective view of an air precleaner according to the present invention with the near side broken away;

FIG. 2 is a side plan view of the precleaner air flow pathways;

FIG. 3 is a perspective view of a lateral half of the precleaner shown in FIG. 1, showing an ejection compartment with an evacuation opening and a particle guide;

FIG. 4 is an exterior perspective view of the precleaner of FIGS. 1-3; and

FIG. 5 is a bottom plan view of the precleaner of FIGS. 1-4.

FIG. 6 is a perspective view of an embodiment in which the precleaner is mounted on a engine compartment.

FIG. 7 is a perspective view of an embodiment in which the precleaner is mounted on a cooling package.

### DETAILED DESCRIPTION OF THE PREFERRED EMBODIMENTS

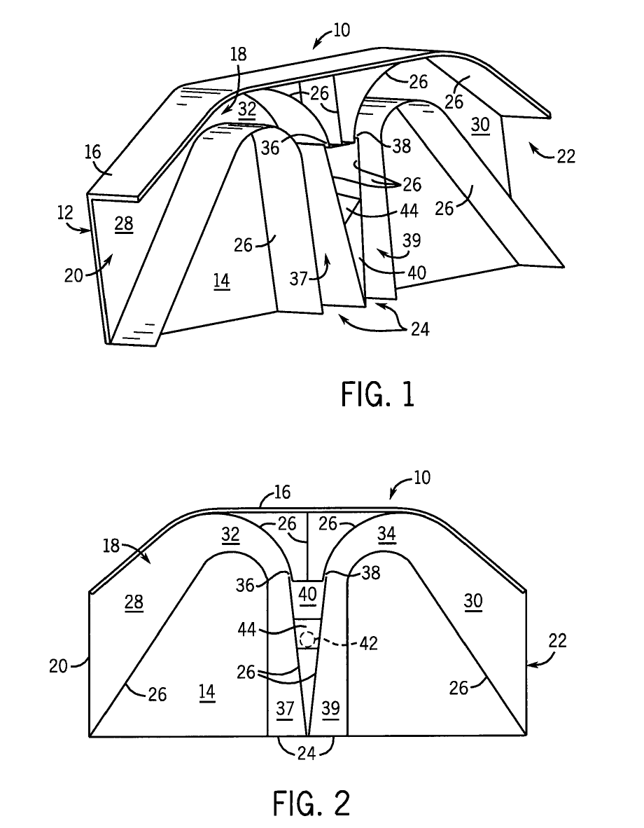

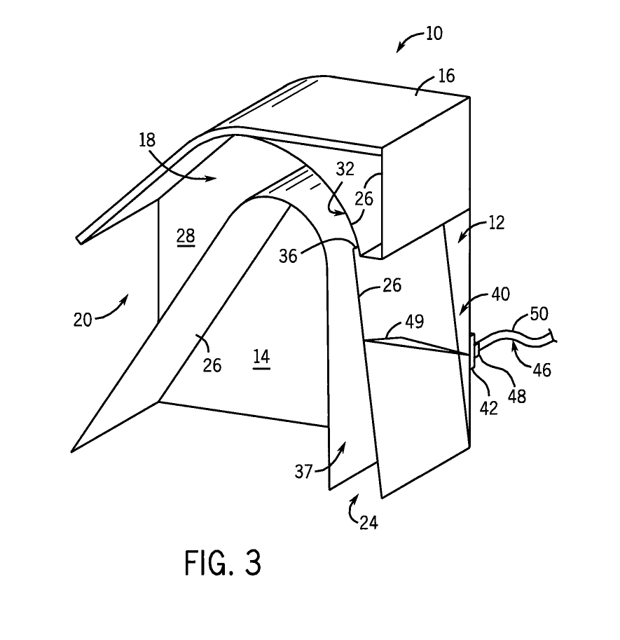

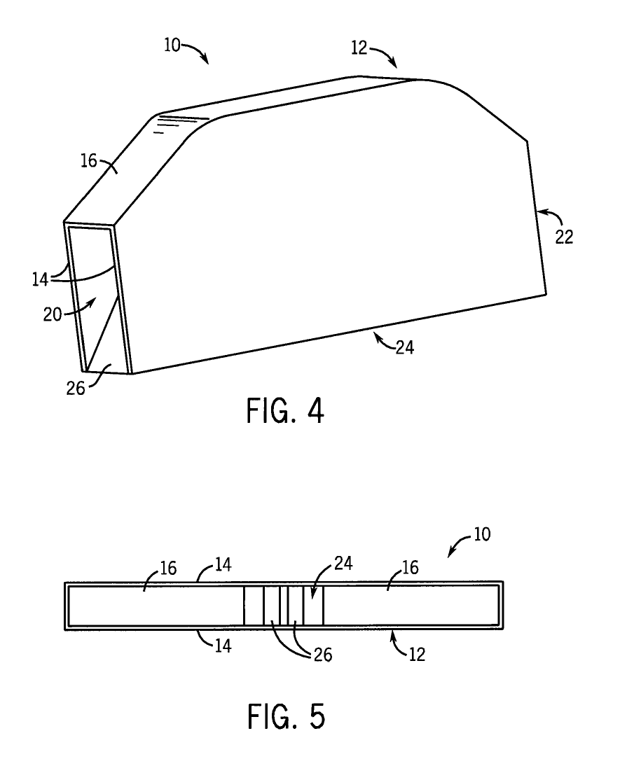

Referring to FIGS. 1-5, a precleaner 10 of the present invention has a housing 12 with opposite planar sides 14 and lateral side walls 16 defining an air chamber 18. The air chamber 18 has two opposite inlet openings 20 and 22 at the ends and a central outlet opening 24. The housing 12 contains a plurality of smooth vanes 26 extending perpendicularly between the sides 14. To promote easy formation and assembly of the precleaner 10, it is contemplated that at least one of the sides 14 and the vanes 26 may be integrally molded from a suitable polymer. Wire mesh screens may be disposed over the inlet openings 20 and 22 to prevent large debris from entering the precleaner 10.

The vanes 26 are arranged and shaped to have curved and straight portions as needed to define two air flow pathways 28 and 30 leading from each respective inlet openings 20 and 22 to the outlet opening 24. The pathways 28 and 30 are widest, that is have the greatest cross-sectional area, at the inlet openings 20 and 22. The pathways 28 and 30 taper inward gradually to bend regions 32 and 34, respectively, where the pathways 28 and 30 turn or change directions more than 90 degrees, preferably about 165 degrees. The pathways 28 and 30 continue narrowing until the end of the bend regions 32 and 34, after which diffuser sections 37 and 39 of the respective pathways 28 and 30 gradually widen to the outlet opening 24.

Ejection openings 36 and 38 extending between the sides 14 are at the end of the bend regions 32 and 34 along the outer diameter. The ejection openings 36 and 38 lead to an particulate collection compartment 40 between the widening portions of the pathways 28 and 30. As shown, the ejection openings 36 and 38 are slits formed in the outer wall of the pathways 28 and 30 by the vanes 26. The back side 14 can include an evacuation opening 42, shown in FIG. 3, leading from the particulate collection compartment 40. In that case, the particulate collection compartment 40 includes a particle guide 44 leading to the evacuation opening 42. The particle guide 44 is preferably sloped from the direction of the ejection openings 36 and 38 down to the evacuation opening 42, so that particles can be directed to the evacuation opening 42 by gravity.

Although shown by itself in FIGS. 1-5, in use the precleaner 10 could be placed in the intake air circuit of a combustion engine. Specifically, the outlet opening 24 could be coupled to suitable flexible tubing of suitable diameter, such as four inches. A separate or integrally molded transition member having a circular cross-section could be used to couple the outlet opening 24 to the tubing. The tubing could lead to the air filter for further elimination of the entrained particles before the intake air passes to the engine intake manifold.

Also, a particle scavenger 46 may be attached to the precleaner 10. Specifically, the evacuation opening 42 may also be fit with an integrally molded or separated attached nipple 48 for connecting suitable flexible hose 50 leading from an exhaust element, such as a muffler. This will cause negative pressure in the particulate collection compartment 40 and draw out the collected debris.

The benefits of the simple design of the precleaner 10 result from the controlled air flow passing through the smooth contours of the pathways 28 and 30. In particular, the air flow rates through the pathways 28 and 30 are increased through the respective bend regions 32 and 34 due to the gradual narrowing of the cross-sectional area of the pathways 28 and 30 to this point. This increase in velocity increases the centrifugal force acting on the entrained particles as the air passes through the bend regions 32 and 34, thereby improving particulate separation. Yet because the air flow rate is increased gradually, it does not become turbulent, such that air entering the inlet openings 20 and 22 in laminar flow remains essentially laminar throughout the precleaner 10. High-speed laminar flow minimizes pressure losses through the precleaner 10. Then, the air flow rates are gradually reduced as the pathways 28 and 30 increase in cross-sectional area in the diffuser sections 37 and 39 (from the end of the respective bend regions 32 and 34 to the outlet opening 24). This gradual increase in cross-section and decrease in velocity avoids a significant pressure drop that could otherwise occur from an abrupt change in cross-section and velocity or abrupt uncontrolled changed in direction in the transition to an air line leading to the air cleaner.

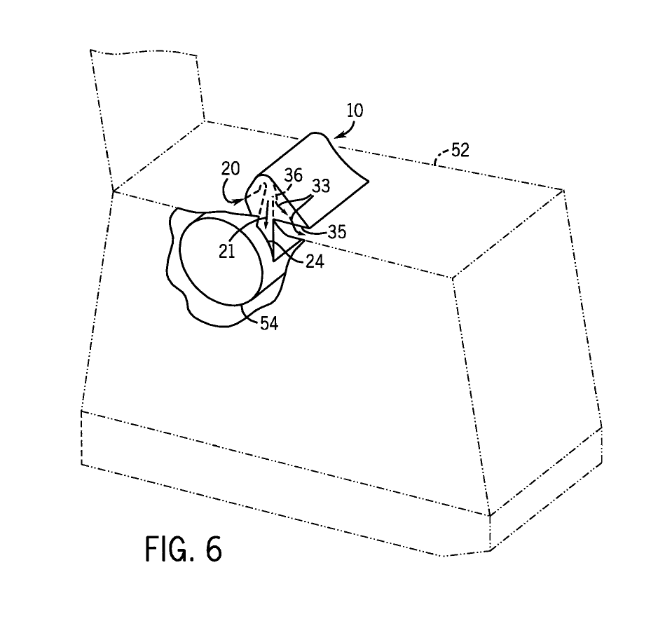

Referring now to FIG. 6, an embodiment is shown schematically in which the precleaner 10 is located on an engine compartment 52. The precleaner 10 is positioned on the surface of the engine compartment 52 such that air flow is permitted into inlet opening 20 from the outside of the engine compartment 52. The air is cleaned as it flows through the precleaner 10 and then the cleaned air follows path 21 and passes out the central outlet opening 24 into the air cleaner 54. Debris exits the entrained air stream through ejection opening 36 and follows a pathway 33 to exit the precleaner 10 through debris outlet 35. As shown, the air cleaner 54 is positioned such that, as the cleaned air exits the central outlet opening 24, the cleaned air tangentially flows into the air cleaner 54. The precleaner 10 in FIG. 6 is illustrated with a single inlet air passageway (from inlet opening 20 past ejection opening 36 to outlet opening 24), but it could have two passageways like in the embodiment of FIG. 1 (with a second inlet opening 22, ejection opening 38 and outlet opening 24). If two passageways are provided, then a particle guide and evacuation opening could be provided, as described above, between the passageways to evacuate the debris that is separated from the air stream.

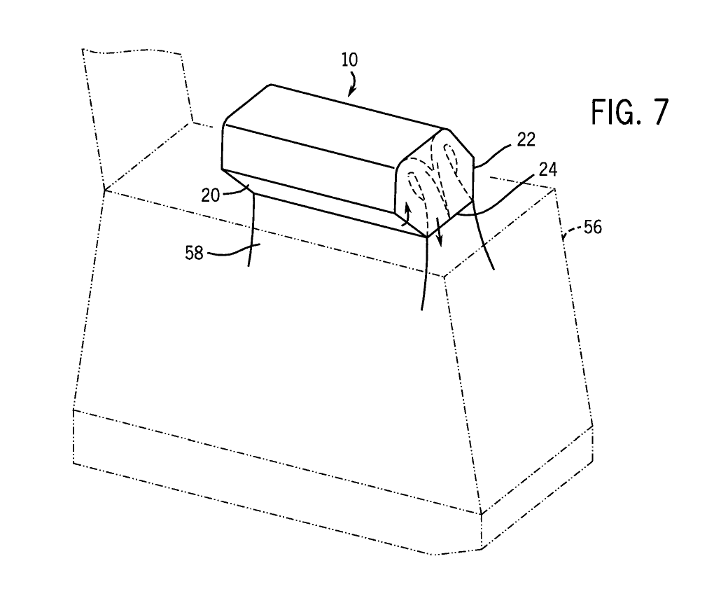

Referring now to FIG. 7, another embodiment is shown in which the precleaner 10 is located on a cooling package 56. Again, the precleaner 10 is positioned on the surface of the cooling package 56 such that air flow is permitted into inlet openings 20 and 22. The air is cleaned as it flows through the precleaner 10 and out of the central outlet opening 24. The central outlet opening 24 is connected to ducting 58 which connects to the cooling package 56. The cooling package 56 may be used to cool, for example, vehicle cabin air.

Thus, the present invention provides an efficient air precleaner for reducing or eliminating airborne contaminants from engine intake air prior to entering the air filter. The precleaner is designed to control the air flow to significantly reduce static and dynamic pressure losses that would otherwise occur in less efficient precleaners, resulting from high flow velocities, abrupt change of direction, and uncontrolled deceleration. Reducing the pressure losses ultimately improves the efficiency and power output of the engine. Keeping both pressure loss low and cleaning efficiency high could mean reduced overall size of air cleaner components, thereby providing the benefit of a more compact unit. Moreover, the precleaner allows for the collected debris to be evacuated at a location away from the inlet manifold to prevent reentry of the debris into the precleaner

Preferred embodiments of the invention have been described in considerable detail. Many modifications and variations to the preferred embodiments will be apparent to those skilled in the art, which will be within the spirit and scope of the invention. For example, the precleaner could be formed to include only one or more inlet openings with corresponding pathways for the air to pass through. Therefore, the invention should not be limited to the described embodiments, but should be defined with reference to the following claims.

I claim:

1. An air precleaner for use with an air filter to remove entrained contaminants from intake air prior to entering the air filter, the air precleaner comprising:
a housing having side walls defining an air chamber, and an inlet opening allowing intake air into the air chamber and an outlet opening, wherein the inlet opening has a greater cross-sectional area than the outlet opening; and
a plurality of vanes in the air chamber between opposite side walls of the housing, the vanes and sidewalls defining a pathway for intake air to flow from the inlet opening around a bend of more than 90 degrees to the outlet opening, from the inlet opening to the outlet opening the pathway gradually narrowing so as to increase the velocity of the intake air from the inlet opening to the end of the bend, and wherein an ejection opening for receiving contaminants transferred to an outer layer of the intake air by centrifugal force caused by the intake air passing around the bend is positioned along an outer perimeter of the bend, and wherein the pathway gradually widens so as to decrease the velocity of the intake air from the ejection opening to the outlet opening.

2. The precleaner of claim 1, wherein the ejection opening is located on the outer perimeter of the bend proximate a location at which the pathway begins to gradually widen.

3. The precleaner of claim 1, wherein the housing defines an ejection compartment adjacent the ejection opening for collecting contaminants from the intake air passing through the ejection opening.

4. The precleaner of claim 3, wherein the housing defines an evacuation opening in the ejection compartment for evacuating contaminants in the ejection compartment.

5. The precleaner of claim 4, wherein the ejection compartment is located so that particles entering the ejection opening can pass to the ejection compartment by gravity.

6. The precleaner of claim 5, wherein the ejection compartment includes a particle guide extending to the evacuation opening to direct particles passing through the ejection opening to the evacuation opening.

7. The precleaner of claim 6, further comprising a particle scavenger in fluid communication with the evacuation opening.

8. The precleaner of claim 1, wherein an evacuation opening is spaced apart from the inlet opening.

9. The precleaner of claim 8, wherein the inlet opening is perpendicular to the outlet opening.

10. The precleaner of claim 9, wherein the outlet opening opens to a bottom side of the housing.

11. The precleaner of claim 1, wherein the housing includes a second inlet opening and a second plurality of vanes defining a second pathway extending from the second inlet opening to the outlet opening.

12. The precleaner of claim 1, wherein the pathway is contoured and the vanes are sufficiently smooth to allow intake air entering the inlet opening in a laminar state to remain substantially laminar to the outlet opening.

13. The precleaner of claim 1, further comprising an air cleaner for an internal combustion engine in fluid communication with the outlet opening of the precleaner.

14. The precleaner of claim 1, further comprising a cooling package in fluid communication with the outlet opening of the precleaner.
